(19) United States
(12) Patent Application Publication
(10) Pub. No.: US 2022/0241668 A1
(43) Pub. Date: Aug. 4, 2022

(54) EXERCISE SYSTEM DISPLAY DEVICE SUPPORT

(71) Applicant: ICON Health & Fitness, Inc., Logan, UT (US)

(72) Inventors: Jared Willardson, Smithfield, UT (US); Scott R. Watterson, Providence, UT (US)

(21) Appl. No.: 17/476,899

(22) Filed: Sep. 16, 2021

Related U.S. Application Data
(60) Provisional application No. 63/079,697, filed on Sep. 17, 2020.

(51) Int. Cl. A63B 71/06; A47G 1/00; F16B 1/00

(52) U.S. Cl. CPC A63B 71/0622; A47G 1/00; F16B 1/00; A63B 2071/0647; A63B 2209/08; A63B 2225/12; A63B 2225/685; F16B 2001/0035

(57) ABSTRACT

An exercise system includes an exercise system display including magnetic material and a displayable area. A support device is magnetically connected to the exercise system display to support a mobile device. The mobile device covers a portion of the displayable area. The mobile device is movable so that a user can move the mobile device to a convenient viewing location.

### CROSS-REFERENCE TO RELATED APPLICATIONS

This application claims priority to and the benefit of U.S. Provisional Patent Application No. 63/079,697, filed on Sep. 17, 2020, which is hereby incorporated by reference in its entirety.

### BACKGROUND

### Background and Relevant Art

An exercise device may include one or more displays. The display may be used to display exercise information, such as current exercise, calories burned, weight, and other exercise information. The display may include videos, graphical information, instructions, and other exercise information.

### BRIEF SUMMARY

In some embodiments, an exercise system may include a first display having a magnetic surface. A support device for holding a table includes a magnetic connector configured to connect to the magnetic surface. A support surface extends laterally from the magnetic connector and a lip may extend up from the support surface. In some embodiments, the support device may support a mobile device. In some embodiments, the mobile device may block a portion of the exercise device display.

In other embodiments, a method for an exercise system includes magnetically attaching a support device to an exercise system display. A second display is supported using the support device. In some embodiments, the method further includes covering a portion of the first display with the second display

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a support device, according to at least one embodiment of the present disclosure;

FIG. 2-1 and FIG. 2-2 are representations of an exercise system, according to at least one embodiment of the present disclosure;

FIG. 3 is a representation of another support device, according to at least one embodiment of the present disclosure; and

FIG. 4 is a representation of a method for performing an exercise, according to at least one embodiment of the present disclosure.

### DETAILED DESCRIPTION

This disclosure generally relates to devices, systems, and methods for a display for an exercise device. An exercise device may include an exercise device display. In some embodiments, the display may display exercise information. For example, the exercise device display may display exercise information such as instructional and/or motivational videos, exercise data of the user, such as heartrate, calories burned, cadence, weight, duration of exercise, other exercise data, and combinations thereof. In some embodiments, the exercise device display may be mirrored. In other words, the exercise device display may have a display surface. The display surface may have a mirrored finish such that a reflection is visible simultaneously with the display. for example, the exercise device display may present exercise information such as exercise form, and a user may stand such that his reflection is overlayed over the exercise form. This may help improve a user's form and/or help the user to use the correct form.

A user may desire to use a second display to present information. For example, a user may desire to watch a movie and/or television show. In some embodiments, the user may have a mobile device, such as a smart phone or a tablet, on which he wishes to watch a show. The user may place a support device on the exercise device display and may place the mobile device on the support device. In this manner, the user may watch the exercise information on the display of the exercise device, while simultaneously watching the show on the mobile device. In some embodiments, the mobile device may include exercise information. for example, the exercise device may include exercise information, such as an exercise program, that is complementary (e.g., works with) the exercise information on the exercise device display. In some embodiments, the mobile device may display exercise information unrelated to the exercise information on the exercise device display.

In some embodiments, the support device may magnetically connect to the display such that the support device is movable about the display. In this manner, the support device may be moved to a comfortable viewing location for the user. In some embodiments, the exercise device display may include a magnetic surface. The support device may include magnets to magnetically connect to the magnetic surface. Thus, the support device may magnetically connect to the exercise device display anywhere on the magnetic surface. In some embodiments, the support device may cover a portion of the exercise device display. For example, the exercise device display may be located at a height that is inconvenient or not visible to the user. The user may move the support device such that the mobile device covers a portion of the display, which may allow the user to easily view the information (e.g., the show and/or the exercise information) on the mobile device.

The exercise device may be any exercise device. For example, the exercise device may be an exercise mirror. The exercise mirror may include a mirrored display, in which a user may simultaneously view herself exercise while viewing information presented on the display. In some embodiments, the exercise device may be a cable exercise device, and the display may be a display of the cable exercise device. In some embodiments, the exercise device may be a treadmill, an elliptical, a stationary bicycle, a rowing machine, or any other exercise device, and the exercise device display may be the display of the exercise device.

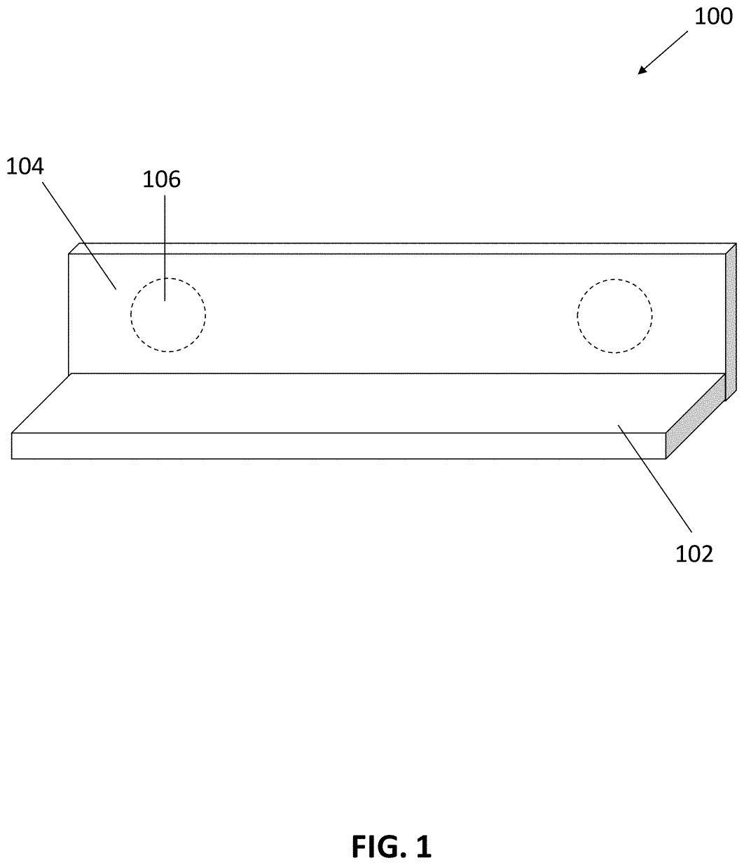

Referring now to the figures, FIG. 1 is a representation of a support device 100, according to at least one embodiment of the present disclosure. The support device 100 includes a support surface 102 and a magnetic connector 104. The support surface 102 may extend laterally away from the magnetic connector 104. The support surface 102 may be configured to support and/or hold a mobile device during an exercise program. In some embodiments, the magnetic connector 104 includes one or more magnets 106. The magnets 106 may be used to connect the support device 100 to a display.

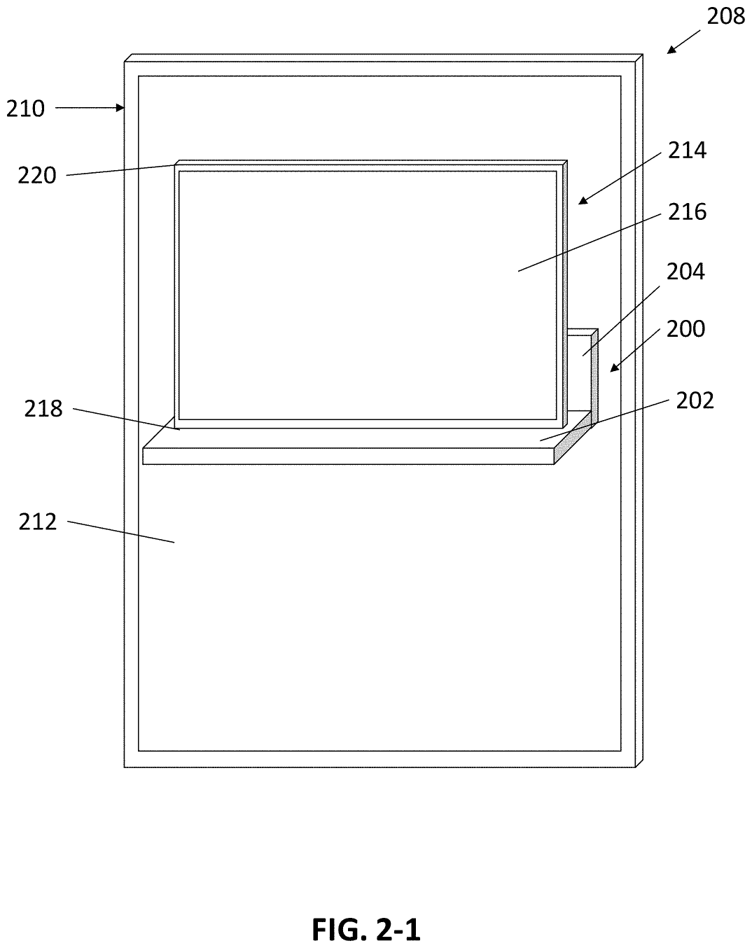

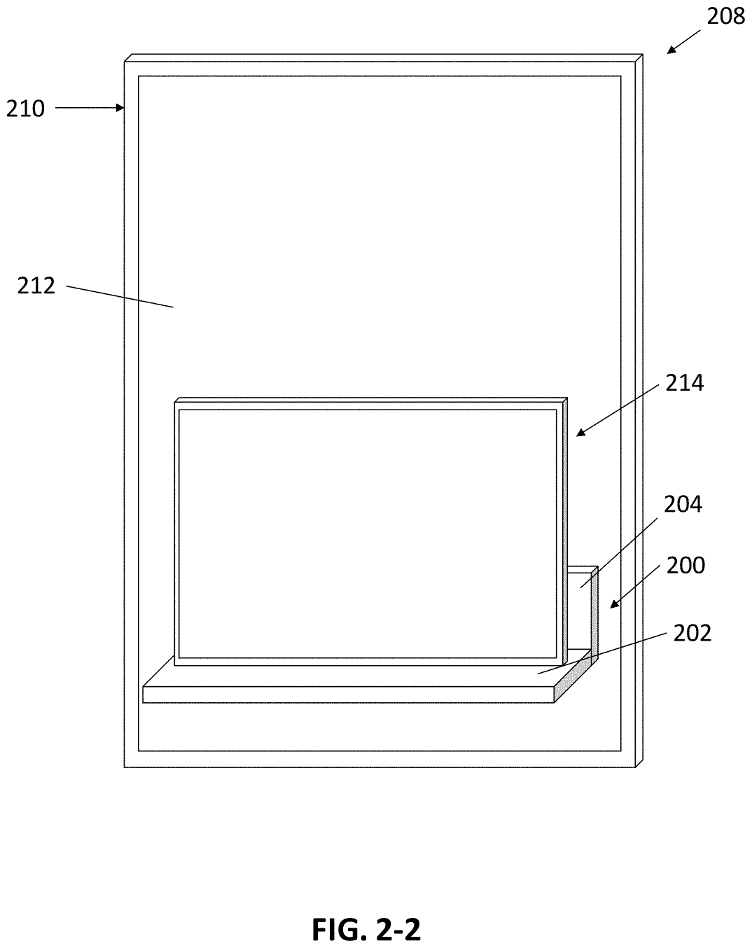

FIG. 2-1 is a representation of an exercise system 208, according to at least one embodiment of the present disclosure. The exercise system 208 may include an exercise system display 210 having a displayable area 212. The exercise system display 210 may be any exercise system display, including a display on an exercise mirror, a cable machine, a rowing machine, a treadmill, a stationary bicycle, an elliptical, or any other exercise machine.

The exercise system 208 includes a support device 200. A mobile device 214 is supported by the support surface 202 of the support device 200. The mobile device 214 includes a mobile device display 216. In some embodiments, the mobile device 214 may be any mobile device, such as a smart phone, a tablet, or any other mobile device 214. In some embodiments, a lower surface 218 of the mobile device 214 may be supported by the support surface 202, and an upper surface 220 may be supported by the exercise system display 210.

In some embodiments, the exercise system display 210 may include magnetic material. In some embodiments, the support device 200 may include a magnetic connection 204. The magnetic connection 204 may include one or more magnets. The one or more magnets from the magnetic connection 204 may connect to the magnetic material in the exercise system display 210. The magnets may be strong enough to support the display of the mobile device 214. In other words, the magnetic connection 204 (and the included magnets) may have a magnetic strength sufficient to support the mobile device 214.

In some embodiments, the magnetic material on the exercise system display 210 may include magnetic material throughout an entirety of its surface. In this manner, the support device 200 may be placed at any location on the exercise system display 210. In some embodiments, the exercise system display 210 may include magnetic material along only a portion of its surface. In this manner, the support device 200 may be placed only where the magnetic material is located.

In some embodiments, the support device 200 may cover a portion of the displayable area 212 of the exercise system display 210. Displays are often placed in a location conveniently visible while exercising. However, a user may desire to view different material than the material displayed in the displayable area 212. To view his own material, the user may place the support device 200 on the exercise system display 210. The user may place the mobile device 214 on the support device 200 and cover a portion of the exercise system display 210. In this manner, the user may view his own content in a location that is conveniently visible to the user.

In some embodiments, the support device 200 may be movable on the exercise system display 210. For example, FIG. 2-2 is a representation of the exercise system 208 of FIG. 2-1 where the support device 200 has been moved into a different location than the location shown in FIG. 2-1. In this manner, a user may move the mobile device 214 into a position conveniently visible to the user. In other words, the user may move or change the vertical position of the support device 200 into a convenient or a location where the mobile device 214 is more visible. Because users may be different heights, this may allow the user to relocate the mobile device 214 to a place she can see it better. In some embodiments, moving the support device 200 may allow the user to view different portions of the displayable area 212, thereby allowing the user to view a desired portion of the displayable area 212.

In some embodiments, the magnetic connection 204 may include a soft lining, such as a fabric lining, between the magnetic connection 204 and the exercise system display 210. This may help to reduce scratching of the exercise system display when moving the support device 200 on the exercise system display 210.

In some embodiments, the support surface 202 may be a lower support surface and the support device 200 may further include an upper surface. The upper surface may be configured to contact an upper face of the mobile device 214. The support surface 202 and the upper surface may apply a compressive force to the mobile device 214. In some embodiments, the support device 200 may be a clamshell-type support device.

In some embodiments, the support surface 202 may be connected to the exercise system display 210 with a hinged connection. The hinged connection may allow the support surface 202 to be moved to different lateral and/or vertical locations. In other words, the hinged connection may include one or both of a vertical pivot or a horizontal pivot. In some embodiments, the hinged connection may allow the support surface 202 to tilt forward or backward to further improve the viewing angle for the user.

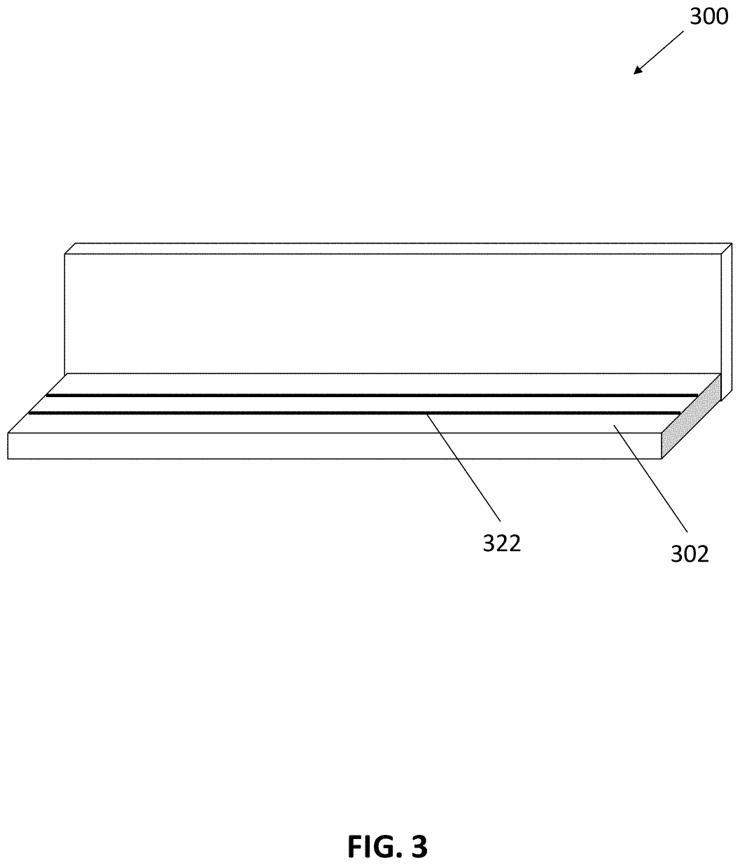

FIG. 3 is a representation of a support device 300, according to at least one embodiment of the present disclosure. In the embodiment shown, the support device 300 includes a support surface 302. The support surface 302 may include one or more support ridges 322. The support ridges 322 may be depressions and/or ridges on the support surface 302. This may allow for multiple display angles of the mobile device (e.g., mobile device 214 of FIG. 2-1), based on the position of the lower surface of the mobile device and the leaning of the mobile device against the exercise system display and the support surface 302.

In some embodiments, the support surface 302 may include a lip at the lateral end of the support surface. The lip may help to prevent the mobile device from sliding off the support surface during use.

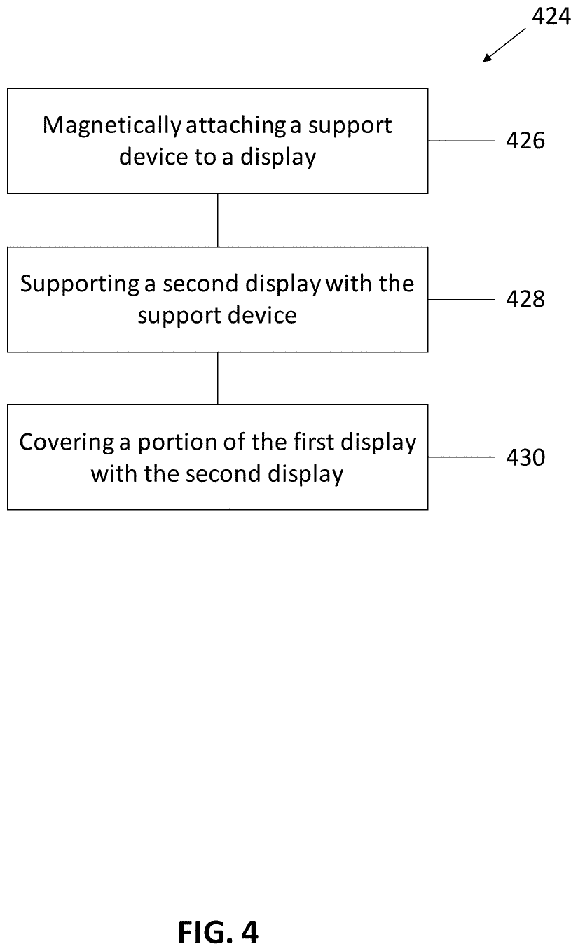

FIG. 4 is a representation of a method 424 for performing an exercise. In some embodiments, the method may include magnetically attaching a support device to an exercise system display at 426. A second display may be supported using the support device at 428. In some embodiments, the method 424 may further include covering a portion of the first display with the second display at 430.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A device for holding a mobile device, comprising:
a magnetic connector configured to connect to a magnetic surface of an exercise mirror;
a support surface extending laterally from the magnetic connector; and
a lip extending up from the support surface.

2. The device of claim 1, wherein the magnetic connector covers a portion of a display of the exercise mirror.

3. The device of claim 1, wherein the magnetic connector includes a plurality of magnets.

4. The device of claim 1, wherein the support surface includes a plurality of support ridges.

5. The device of claim 1, wherein the support surface is a lower support surface configured to support a lower surface of the mobile device, and further comprising an upper surface configured to support an upper face of the mobile device.

6. The device of claim 5, wherein the upper surface and the lower support surface are configured to provide a compressive force on the mobile device.

7. The device of claim 1, wherein the magnetic connector is connected to the support surface with hinged connection.

8. The device of claim 7, wherein the hinged connection includes a vertical pivot and a horizontal pivot.

9. The device of claim 1, further comprising a soft lining between magnetic connector and the magnetic surface.

10. An exercise system, comprising:
a first display, the first display having a magnetic surface; and
support device configured to support a second display, the support device including:
a magnetic connector, the magnetic connector being configured to connect to the magnetic surface of the first display; and
a support surface, the support surface being configured to support the second display, wherein when the support surface supports the second display, the second display is also supported by the first display, and wherein when the support surface supports the second display, the second display blocks a portion of the first display.

11. The exercise system of claim 10, wherein the second display includes a mobile device.

12. The exercise system of claim 10, wherein the first display is a mirrored display.

13. The exercise system of claim 10, wherein the first display and the second display display different content.

14. The exercise system of claim 10, wherein the magnetic connector includes a plurality of magnets.

15. The exercise system of claim 10, wherein the magnetic connector has a magnetic strength sufficient to support the second display when the support surface supports the second display.

16. A method for performing an exercise program, comprising:
magnetically attaching a support device to a first display, the first display including a magnetic surface and the support device including a magnet;
supporting a second display with the support device; and
covering a portion of the first display with the second display.

17. The method of claim 16, further comprising displaying first content on the first display and displaying second content with the second display.

18. The method of claim 17, wherein the second content on the second display covers at least a portion of the first content on the first display.

19. The method of claim 17, wherein the first content is an exercise program.

20. The method of claim 16, further comprising moving a vertical position of the support device.
